(19) United States
(12) Patent Application Publication
(10) Pub. No.: US 2026/0048795 A1
(43) Pub. Date: Feb. 19, 2026

(54) VEHICLE COWL STRUCTURE

(71) Applicant: Honda Motor Co., Ltd., Tokyo (JP)

(72) Inventors: Timothy J. Rupp, Dublin, OH (US); Chandra Mouli Murugesan, Marysville, OH (US); Douglas R. Kaltenmark, Powell, OH (US)

(21) Appl. No.: 18/807,238

(22) Filed: Aug. 16, 2024

(51) Int. Cl. B62D 25/08

(52) U.S. Cl. CPC B62D 25/081

(57) ABSTRACT

A vehicle cowl structure for a vehicle having an underbody structure is disclosed. The vehicle cowl structure comprises a cowl top panel extending in a vehicle width direction along a lower end portion of a front windshield. The vehicle cowl structure further comprises a mounting bracket directly coupling the underbody structure to the cowl top panel. The mounting bracket comprises a first portion coupled to the underbody structure. The mounting bracket further comprises a second portion extending angularly from the first portion towards the cowl top panel. The mounting bracket further comprises a third portion extending angularly from the second portion. The third portion couples the mounting bracket with the cowl top panel.

### BACKGROUND

The disclosed subject matter relates generally to a vehicle. More particularly, the disclosed subject matter relates to a vehicle cowl structure.

Conventionally, a vehicle cowl top is supported by a cross bar extending in a vehicle width direction to provide front edge stability to vehicles. The cross bar is secured to an underbody structure of a vehicle body. However, inclusion of the cross bar increases overall weight of the vehicles. Moreover, installation of the cross bar to the underbody structure of the vehicles is a complex and time-consuming process, which requires precise alignment, making the installation of the cross bar more cumbersome, which is undesirable.

### SUMMARY

In accordance with one embodiment of the present disclosure, a vehicle cowl structure for a vehicle having an underbody structure is disclosed. The vehicle cowl structure comprises a cowl top panel extending in a vehicle width direction along a lower end portion of a front windshield. The vehicle cowl structure further comprises a mounting bracket directly coupling the underbody structure to the cowl top panel. The mounting bracket comprises a first portion coupled to the underbody structure. The mounting bracket further comprises a second portion extending angularly from the first portion towards the cowl top panel. Furthermore, the mounting bracket comprises a third portion extending angularly from the second portion. The third portion couples the mounting bracket with the cowl top panel.

In accordance with another embodiment of the present disclosure, a vehicle front structure for a vehicle having an underbody structure is disclosed. The vehicle front structure comprises a pair of pillars. The vehicle front structure further comprises a front windshield arranged between the pair of pillars and including a lower end portion. The vehicle front structure further comprises a vehicle cowl structure. The vehicle cowl structure comprises a cowl top panel extending in a vehicle width direction along the lower end portion of the front windshield. The vehicle cowl structure further comprises a mounting bracket directly coupling the underbody structure to the cowl top panel. The mounting bracket comprises a first portion coupled to the underbody structure. The mounting bracket further comprises a second portion extending angularly from the first portion towards the cowl top panel. Furthermore, the mounting bracket comprises a third portion extending angularly from the second portion. The third portion couples the mounting bracket with the cowl top panel.

In accordance with yet a further embodiment of the present disclosure, a vehicle is disclosed. The vehicle comprises a roof. The vehicle further comprises an underbody structure. The vehicle further comprises a vehicle front structure coupled to the roof and extending towards a front end of the vehicle. The vehicle front structure includes a pair of pillars. The vehicle front structure further includes a front windshield arranged between the pair of pillars and including a lower end portion. The vehicle front structure further includes a vehicle cowl structure. The vehicle cowl structure comprises a cowl top panel extending in a vehicle width direction along the lower end portion of the front windshield. The vehicle cowl structure further comprises a mounting bracket directly coupling the underbody structure to the cowl top panel. The mounting bracket comprises a first portion coupled to the underbody structure. The mounting bracket further comprises a second portion extending angularly from the first portion towards the cowl top panel. Furthermore, the mounting bracket comprises a third portion extending angularly from the second portion. The third portion couples the mounting bracket with the cowl top panel.

### BRIEF DESCRIPTION OF THE DRAWINGS

Certain embodiments of the present disclosure will be better understood from the following description taken in conjunction with the accompanying drawings in which:

FIG. 1 is a perspective view of a vehicle showing a vehicle front structure, in accordance with an embodiment of the present disclosure;

FIG. 2 is a front perspective view of a vehicle cowl structure associated with the vehicle of FIG. 1, in accordance with an embodiment of the present disclosure;

FIG. 3 is a sectional view of the vehicle cowl structure of FIG. 2, in accordance with an embodiment of the present disclosure;

FIG. 4A is a perspective view of a mounting bracket associated with the vehicle cowl structure of FIG. 2, in accordance with an embodiment of the present disclosure;

FIG. 4B is a perspective view of a mounting bracket associated with the vehicle cowl structure of FIG. 2, in accordance with another embodiment of the present disclosure; and

FIG. 5 is a sectional view of the vehicle cowl structure of FIG. 2, in accordance with another embodiment of the present disclosure.

### DETAILED DESCRIPTION OF EXEMPLARY EMBODIMENTS

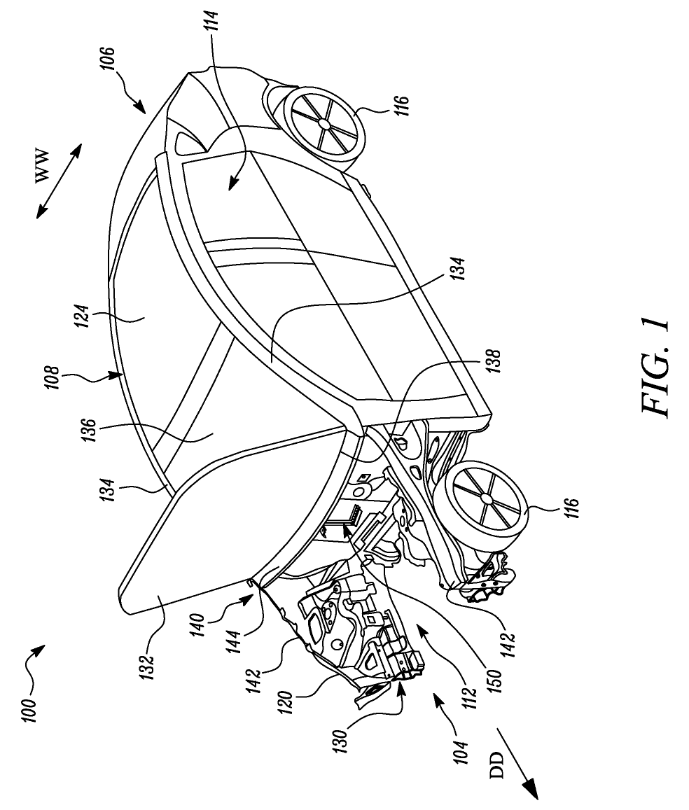

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-5, wherein like numbers indicate the same or corresponding elements throughout the views.

FIG. 1 illustrates a perspective view of a vehicle 100, in accordance with an embodiment of the present disclosure. As shown, the vehicle 100 includes a front end 104, a rear end 106, and a body structure 108 extending longitudinally from the front end 104 to the rear end 106. Further, the body structure 108 defines an engine compartment 112 and a passenger compartment 114 for facilitating seating of one or more passengers inside the vehicle 100. The vehicle 100 further includes a plurality of wheels 116 for supporting the body structure 108 on a ground surface (not shown) and enables a movement of the vehicle 100 over the ground surface. Although the vehicle 100 is shown as a sedan, it may be appreciated that the vehicle 100 may include any other type of vehicles, such as, but not limited to, coupes, sport utility vehicles (SUVs), bus etc.

Further, the vehicle 100 includes an underbody structure 120 having a floor (not shown) on which one or more seats (not shown) may be mounted. The vehicle 100 further includes a roof 124 disposed opposite to the floor. The vehicle 100 further includes a vehicle front structure 130 coupled to the roof 124 and extending towards the front end 104 of the vehicle 100. The vehicle front structure 130 includes a hood 132 arranged for covering the engine compartment 112 of the vehicle 100. Further, the vehicle front structure 130 includes a pair of pillars 134. The pair of pillars 134 is illustrated as A-pillars supporting the roof 124 of the vehicle 100. The vehicle front structure 130 further includes a front windshield 136 arranged between the pair of pillars 134. The front windshield 136 includes a lower end portion 138 disposed towards the hood 132 of the vehicle 100. The vehicle front structure 130 further includes a vehicle cowl structure 140 disposed proximate to the lower end portion 138 of the front windshield 136.

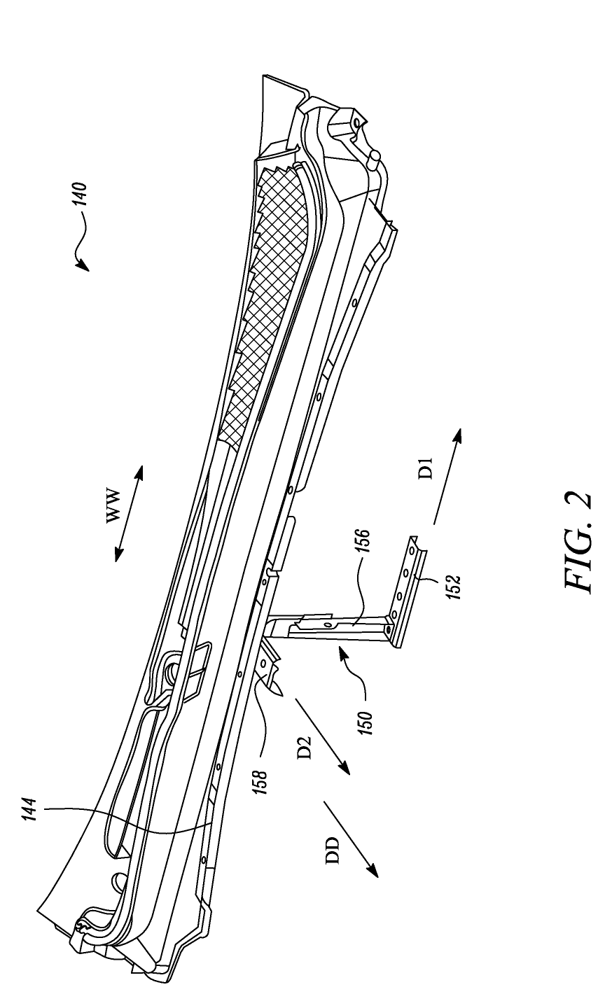

FIG. 2 illustrates a front perspective view of the vehicle cowl structure 140, in accordance with an embodiment of the present disclosure. Referring now to FIGS. 1 and 2, the vehicle cowl structure 140 extends horizontally between side panels 142 (as shown in FIG. 1) of the vehicle 100. The vehicle cowl structure 140 includes a cowl top panel 144 extending in a vehicle width direction WW along the lower end portion 138 of the front windshield 136 (as shown in FIG. 1). As shown in FIG. 1, the cowl top panel 144 extends between the pair of pillars 134 of the vehicle 100, such that each end of the cowl top panel 144 is supported by a damper assembly (not shown) disposed within the side panels 142 of the vehicle 100.

The vehicle cowl structure 140 further includes a mounting bracket 150 disposed centrally relative to the cowl top panel 144 and coupling the cowl top panel 144 to the underbody structure 120 (as shown in FIG. 1), thereby providing additional support to the cowl top panel 144. In the illustrated embodiment of FIG. 1, the mounting bracket 150 directly couples the cowl top panel 144 to the underbody structure 120 of the vehicle 100. In some embodiments, the mounting bracket 150 couples the cowl top panel 144 to other brackets or components, such as battery mounting brackets (not shown) of the underbody structure 120. The mounting bracket 150 includes a first portion 152, a second portion 156, and a third portion 158. The first portion 152 extends in a first horizontal direction D1 perpendicular to a direction of movement DD of the vehicle 100. Further, the third portion 158 extends in a second horizontal direction D2 parallel to the direction of movement DD of the vehicle 100.

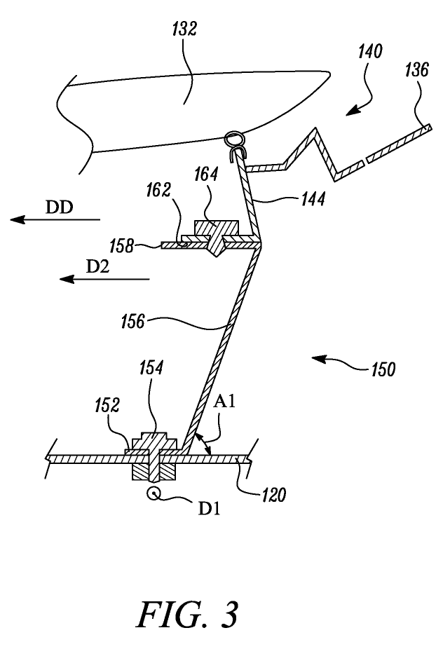

FIG. 3 illustrates a sectional view of the vehicle cowl structure 140, in accordance with an embodiment of the present disclosure. The mounting bracket 150 includes the first portion 152 coupled to the underbody structure 120. In some embodiments, the first portion 152 is coupled to the underbody structure 120 by one or more mechanical fasteners 154. However, to couple the first portion 152 to the underbody structure 120, any other suitable methods existing in the art, for example, riveting, welding, and/or press-fitting may also be used.

As shown in the illustrated example, the first portion 152 extends in the first horizontal direction D1 perpendicular to the direction of movement DD of the vehicle 100. However, in some other examples, the first portion 152 of the mounting bracket 150 may extend in the direction of movement DD of the vehicle 100. In some embodiments, the first portion 152 of the mounting bracket 150 is directly coupled to the underbody structure 120 via the one or more mechanical fasteners 154. In other embodiments, the first portion 152 of the mounting bracket 150 may be coupled to another component, such as battery mounting brackets (not shown) of the underbody structure 120.

As shown in FIG. 3, the second portion 156 extends angularly (i.e., at an angle A1) from the first portion 152 towards the cowl top panel 144. In some embodiments, the angle A1 between the first portion 152 and the second portion 156 of the mounting bracket 150 may vary from 60 degrees to 90 degrees. In the illustrated embodiment of FIG. 3, the angle between the first portion 152 and the second portion 156 is 70 degrees.

Further, the third portion 158 extends angularly from the second portion 156 and contacts a lower surface 162 of the cowl top panel 144. The third portion 158 couples the mounting bracket 150 with the cowl top panel 144. The third portion 158 is coupled to the cowl top panel 144 by one or more mechanical fasteners 164. In an example, the third portion 158 extends in the second horizontal direction D2 parallel to the direction of movement DD of the vehicle 100. Specifically, the third portion 158 of the mounting bracket 150 may extend in the second horizontal direction D2 perpendicular to the first horizontal direction D1. However, in some other examples, the third portion 158 may be parallel to the first portion 152.

Usage of the vehicle cowl structure 140 may eliminate necessity of a cross bar to support the cowl top panel 144, which may lead to reduction in an overall weight of the vehicle 100. The reduction in the overall weight of the vehicle 100 further may improve fuel efficiency of the vehicle 100. Moreover, the mounting bracket 150 of the vehicle cowl bar structure 140 may facilitate easy installation of the vehicle cowl bar structure 140 on the underbody structure 120 of the vehicle 100 while providing required support to the cowl top panel 144, thus ensuring a front edge stability of the vehicle 100.

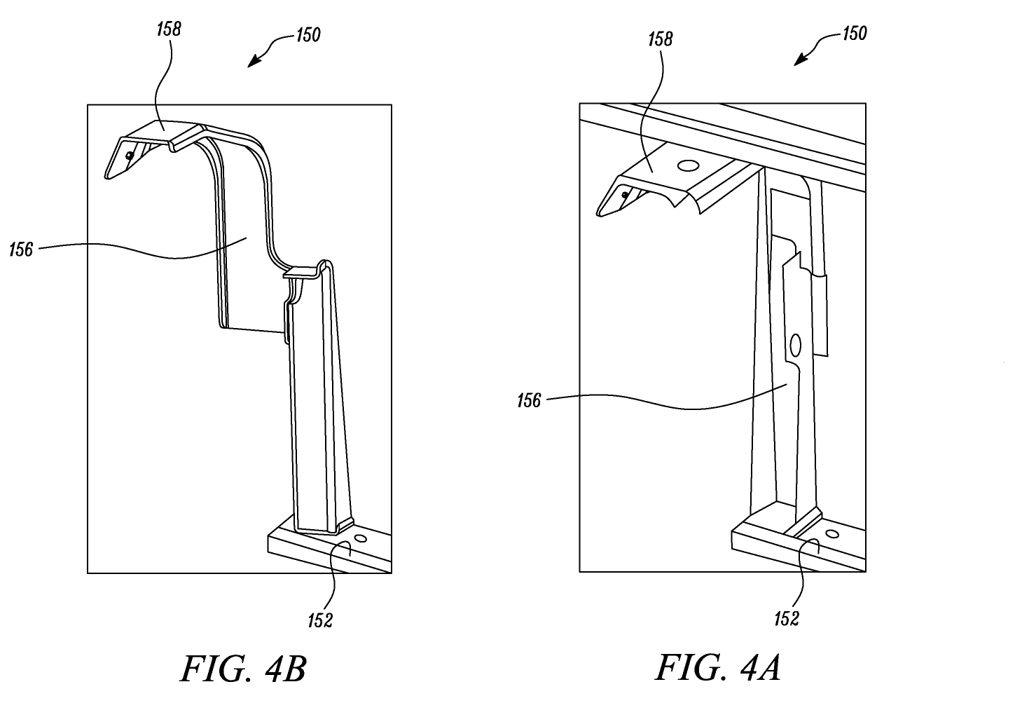

Referring to FIG. 4A, a perspective view of the mounting bracket 150 is shown, according to an embodiment of the present disclosure. As shown in FIG. 4A, the third portion 158 is coupled with the second portion 156 such that the third portion 158 lies vertically above the first portion 152. In other words, the third portion 158 and the first portion 152 lie in a same vertical plane. Referring now to FIG. 4B, the third portion 158 may be coupled with the second portion 156 such that the third portion 158 lies at a vertical offset relative to the first portion 152. In other words, the third portion 158 and the first portion 152 lie in different vertical planes.

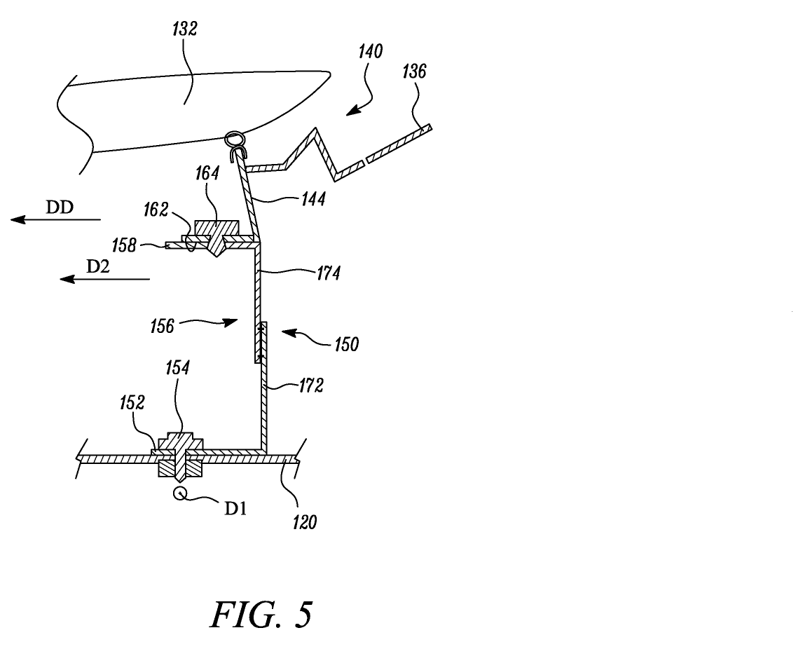

Referring to FIG. 5, a sectional view of the mounting bracket 150 is shown, in accordance with another embodiment of the present disclosure. In the illustrated embodiment of FIG. 5, the second portion 156 of the mounting bracket 150 includes a first element 172 extending angularly from the first portion 152. As shown, the first element 172 extends perpendicularly (i.e., at 90 degrees) from the first portion 152 of the mounting bracket 150. The second portion 156 further includes a second element 174 coupled to the first element 172 at one end and the third portion 158 at another end. In some embodiments, the second element 174 is coupled to the first element 172 by one or more spot welds.

Division of the second portion 156 of the mounting bracket 150 into two parts (i.e., the first element 172 and the second element 174) may provide additional strength to the second portion 156, which may provide an additional support to the cowl top panel 144 of the vehicle 100. This may ensure increased front edge stability of the vehicle 100.

In some embodiments, the third portion 158 may be coupled with the second element 174 (i.e., the second portion 156) such that the third portion 158 lies vertically above the first portion 152 (similar to FIG. 4A). In other words, the third portion 158 and the first portion 152 lie in a same vertical plane. In another embodiment, the third portion 158 may be coupled with the second element 174 (i.e., the second portion 156) such that the third portion 158 lies at a vertical offset relative to the first portion 152 (similar to FIG. 4B). In other words, the third portion 158 and the first portion 152 lie in different vertical planes.

The foregoing description of embodiments and examples has been presented for purposes of illustration and description. It is not intended to be exhaustive or to limit the disclosure to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the disclosure is, of course, not limited to the examples or embodiments set forth herein, but can be employed in any number of applications and equivalent devices by those of ordinary skill in the art. Rather it is hereby intended the scope of the disclosure be defined by the claims appended hereto.

What is claimed is:

1. A vehicle cowl structure for a vehicle having an underbody structure, the vehicle cowl structure comprising:
a cowl top panel extending in a vehicle width direction along a lower end portion of a front windshield; and
a mounting bracket directly coupling the underbody structure to the cowl top panel, the mounting bracket comprising:
a first portion coupled to the underbody structure;
a second portion extending angularly from the first portion towards the cowl top panel; and
a third portion extending angularly from the second portion, the third portion coupling the mounting bracket with the cowl top panel.

2. The vehicle cowl structure of claim 1, wherein the second portion includes:
a first element extending angularly from the first portion; and
a second element coupled to the first element at one end and the third portion at another end.

3. The vehicle cowl structure of claim 2, wherein the second element is coupled to the first element by one or more spot welds.

4. The vehicle cowl structure of claim 2, wherein the third portion is coupled with the second element such that the third portion lies vertically above the first portion.

5. The vehicle cowl structure of claim 2, wherein the third portion is coupled with the second element such that the third portion lies at a vertical offset relative to the first portion.

6. The vehicle cowl structure of claim 1, wherein the third portion is coupled with the second portion such that the third portion lies vertically above the first portion.

7. The vehicle cowl structure of claim 1, wherein the third portion is coupled with the second portion such that the third portion lies at a vertical offset relative to the first portion.

8. The vehicle cowl structure of claim 1, wherein the first portion is coupled to the underbody structure by one or more mechanical fasteners.

9. The vehicle cowl structure of claim 1, wherein the third portion is coupled to the cowl top panel by one or more mechanical fasteners.

10. The vehicle cowl structure of claim 1, wherein the first portion is parallel to the third portion.

11. A vehicle front structure for a vehicle having an underbody structure, the vehicle front structure comprising:
a pair of pillars;
a front windshield arranged between the pair of pillars and including a lower end portion; and
a vehicle cowl structure, comprising:
a cowl top panel extending in a vehicle width direction along the lower end portion of the front windshield; and
a mounting bracket directly coupling the underbody structure to the cowl top panel, the mounting bracket comprising:
a first portion coupled to the underbody structure;
a second portion extending angularly from the first portion towards the cowl top panel; and
a third portion extending angularly from the second portion, the third portion coupling the mounting bracket with the cowl top panel.

12. The vehicle front structure of claim 11, wherein the second portion includes:
a first element extending angularly from the first portion; and
a second element coupled to the first element at one end and the third portion at another end.

13. The vehicle front structure of claim 12, wherein the third portion is coupled with the second element such that the third portion lies vertically above the first portion.

14. The vehicle front structure of claim 12, wherein the third portion is coupled with the second element such that the third portion lies at a vertical offset relative to the first portion.

15. The vehicle front structure of claim 11, wherein the third portion is coupled with the second portion such that the third portion lies vertically above the first portion.

16. The vehicle front structure of claim 11, wherein the third portion is coupled with the second portion such that the third portion lies at a vertical offset relative to the first portion.

17. The vehicle front structure of claim 11, wherein the first portion is parallel to the third portion.

18. A vehicle comprising:
a roof;
an underbody structure; and
a vehicle front structure coupled to the roof and extending towards a front end of the vehicle, the vehicle front structure including:
a pair of pillars;
a front windshield arranged between the pair of pillars and including a lower end portion; and
a vehicle cowl structure, comprising:
a cowl top panel extending in a vehicle width direction along the lower end portion of the front windshield; and
a mounting bracket directly coupling the underbody structure to the cowl top panel, the mounting bracket comprising:
a first portion coupled to the underbody structure;
a second portion extending angularly from the first portion towards the cowl top panel; and
a third portion extending angularly from the second portion, the third portion coupling the mounting bracket with the cowl top panel.

19. The vehicle of claim 18, wherein the second portion includes:
a first element extending angularly from the first portion; and
a second element coupled to the first element at one end and the third portion at another end.

20. The vehicle of claim 18, wherein the first portion is parallel to the third portion.
